(19) United States
(12) Patent Application Publication
(10) Pub. No.: US 2001/0039483 A1
(43) Pub. Date: Nov. 8, 2001

(54) Reduction of inter-subject variation via transfer standardization

(76) Inventors: Derek Brand, Bringhton, MA (US); Jenny Freeman, Weston, MA (US); James Mansfield, Boston, MA (US); Pierre Trepagnier, Medford, MA (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 09/785,550

(22) Filed: Feb. 20, 2001

Related U.S. Application Data
(60) Provisional application No. 60/183,344, filed on Feb. 18, 2000.

(51) Int. Cl. G01D 18/00

(52) U.S. Cl. 702/104

(57) ABSTRACT

This invention relates to the reduction of inter-subject variation via transfer standardization. According to the method, the effects of inter-subject variation on the analysis of spectra collected from the skin of two or more different subjects is reduced by correcting for the differences between spectra collected from said two or more subjects.

### RELATED APPLICATION

The present invention claims priority to U.S. Provisional Patent Application No. 60/183,344, filed Feb. 18, 2000, and titled, “Reduction of Inter-Subject Variation Via Transfer Standardization.”

### BACKGROUND OF THE INVENTION

1. Field of the Invention

This invention relates to reduction of inter-subject variation via transfer standardization and, more specifically, to methods for reducing the effects of inter-subject variation on the analysis of spectra collected from the skin of two or more different subjects, by correcting for the differences between the spectra collected.

2. Description of the Background

There is significant literature on instrument standardization. See, for example, Wang et al., “Multivariate Instrument Standardization,” Anal. Chem., Vol. 63, pp. 2750-2756 (1991); Wang et al., “Improvement of Multivariate Calibration through Instrument Standardization,” Anal. Chem., Vol. 64, pp. 562-584 (1992); and Wang et al., “Additive Background Correction in Multivariate Instrument Standardization,” Anal. Chem., Vol. 67, pp. 2379-2385 (1995).

In addition, U.S. Pat. No. 4,866,644 (Optical Instrument Calibration System); U.S. Pat. No. 5,459,677 (Calibration Transfer for Analytical Instruments); U.S. Pat. No. 5,559,728 (Calibration Transfer for Second Order Analytical Instruments); and U.S. Pat. No. 5,850,623 (Method for Standardizing Raman Spectrometers to Obtain Stable and Transferable Calibrations) all relate to calibration systems for analytical instruments.

The so-called calibration transfer problem in analytical chemistry refers to methods for analytical instrument standardization, e.g., standardizing spectrometers. These methods correct for a difference between two or more instruments, thereby allowing the calibration model from one instrument to be transferred to other instruments. In the case of spectrometers, instrument standardization is necessary to relate measurements made with one spectrometer to those made with another, as small variations between, e.g., individual lamps and gratings in the various instruments would ordinarily cause artifacts in the measured spectra. As discussed below, a similar issue arises when studying biological responses in groups of people.

### SUMMARY OF THE INVENTION

It has been discovered that changes in endogenous skin fluorescence to can be correlated with blood glucose levels, and that blood glucose levels can be determined in vivo by measuring fluorescence spectra emitted from the surface of the skin. See, for example, U.S. patent application Ser. No. 09/287,486, filed Apr. 6, 1999, which is incorporated herein in its entirety by reference. However, variations among individuals as well as variations in the skin on the same individual cause changes in the spectra, thereby complicating analysis.

Calibration using conventional techniques to account for changes in large populations would be impractical For example, in attempting to correlate blood glucose and skin fluorescence, a single person, or a small group of people, could have their skin fluorescence spectra laboriously calibrated to blood glucose levels by simultaneously measuring skin spectra and blood glucose many times per day over a period of several weeks, followed by application of multivariate techniques of one type or another (e.g. neural net analysis, multiple linear regression, partial least squares) to build a robust mathematical model relating their skin spectra to their blood glucose.

The above methodology clearly would be impractical for a large population. However, individual skin spectra are sufficiently dissimilar that a model calculated on one person may, in general, not be directly transferable to another person. Thus, a method of reducing inter-subject variation is needed.

The present invention overcomes this problem by treating people as if they were analytical instruments. The crux of the present invention is to treat different people's biological response to an analyte, such as blood glucose, in the same manner as analytical chemists treat the calibration problem. The analytical chemical methods correct for difference between two or more instruments, thereby allowing the calibration model from one instrument to be transferred to other instruments.

Accordingly, one embodiment of the invention is directed to a method for reducing the effects of inter-subject variation on the analysis of spectra collected from the skin of two or more different subjects, comprising the step of correcting for the differences between spectra collected from the two or more subjects. Preferably, the step of correcting comprises using an inter-subject transfer function. For example, in a preferred embodiment the inter-subject transfer function may comprise application of the following formula:

Spectrum_{A Bi} [symbol]=Spectrum_{Ai}×[<Spectrum_{B}>/<Spectrum_{A}>],

where <Spectrum_{X}> is defined as the mean spectrum of X.

Another embodiment is directed to an instrument for measuring a glucose level of a plurality of individuals comprising means for collecting spectra emitted from a first individual's skin and means for analyzing the collected spectra to determine the individual's glucose level, the means for analyzing comprising means for correcting for variations in spectra among individuals.

Other embodiments and advantages of the invention are set forth in part in the description which follows, and in part, will be obvious from this description, or may be learned from the practice of the invention.

### DESCRIPTION OF THE DRAWINGS

FIG. 1a is a graph depicting the spectra of 6 individuals.

FIG. 1b is a graph depicting the mean spectra of each of the six individuals

FIG. 1c is a graph depicting the transferred spectra from the same six individuals.

FIG. 1d is a graph depicting the mean transferred spectra from the same six individuals.

### DESCRIPTION OF THE INVENTION

As embodied and broadly described herein, the present invention is directed to methods and instrument systems for reducing the effects of inter-subject variation on the analysis of spectra collected from the skin of two or more different subjects by correcting for the differences between spectra collected from the two or more subjects. The present invention allows for a single instrument to be used for determining accurate glucose levels for a variety of different individuals based on spectra collected from those individuals, despite the inherent variations in spectra emitted by different individuals.

As noted, the crux of the present invention is to treat different people's biological response to an analyte, such as blood glucose, in the same manner as analytical chemists treat the calibration problem. The analytical chemical methods correct for difference between two or more instruments thereby allowing the calibration model from one instrument to be transferred to other instruments.

The methods also can be used to correct for the changes, e.g., wavelength drift, over time on a single instrument which eliminates the costly process of recalibration.

The purpose of an inter-subject transfer function is to make different people's skin fluorescence spectra look more like each other, in the same way that inter-instrument transfer functions make different analytical instruments look more like each other.

For instance, one can take the mean spectrum of some group of Subject A's spectra, and divide it into the mean spectrum of some group of Subject B's spectra to create the B/A transfer function. The “mean spectrum” is defined by adding intensities, wavelength-by-wavelength, for a large number of spectra, then dividing each wavelength to form an arithmetic mean.

Then, one can multiply Subject A's spectra, spectrum-by-spectrum, by this transfer function, to morph Subject A into Subject B, i.e., on a skin fluorescence basis. Mathematically, the transfer function is written as follows:

Spectrum_{A Bi} [symbol]=Spectrum_{Ai}×[<Spectrum_{B}>/<Spectrum_{A}>]

where <Spectrum_{X}> is defined as the mean spectrum of X, and Spectrum A and Spectrum B are spectra of different individuals.

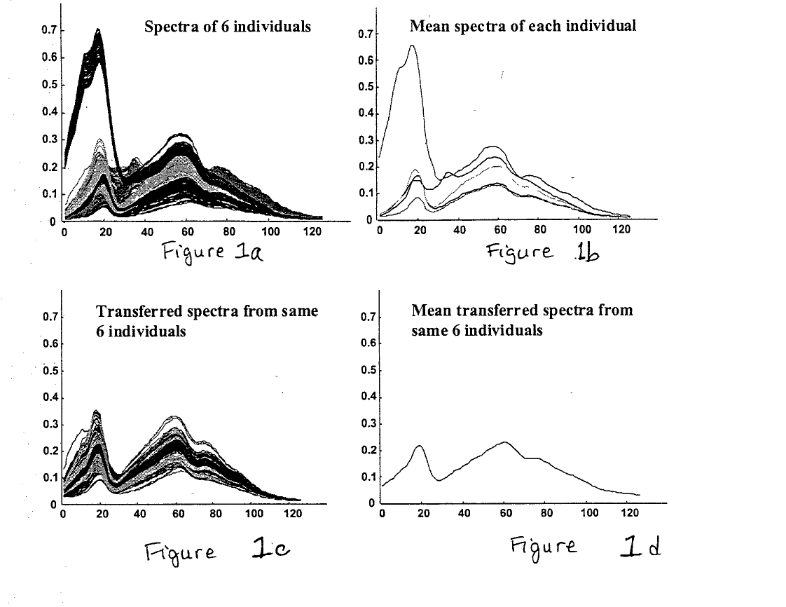

When lumping A and B's spectra together for analysis, artifacts like average intensity and overall spectral shape are eliminated. FIGS. 1a-d illustrates such a process. The upper left panel (FIG. 1a) shows uncorrected fluorescent spectra from 6 individuals. The spectra vary widely person-to-person, as confirmed by the mean spectra, shown in the upper right panel (FIG. 1b). The lower left (FIG. 1c) and lower right panels (FIG. 1d) show the very considerable reduction in inter-person variation achieved by the use of the transfer function technique. This reduction in inter-subject variation is crucial when applying a common algorithm to a large, disparate population.

The technique of the present invention allows for, among other things: a more precise analysis with fewer analytical variables devoted to essentially irrelevant inter-person variation; a more universal calibration function for the population at large; a method for transferring calibrations, e.g., glucose calibrations, from one person to another; and a method for transferring calibrations within one person, e.g. from one site to a dissimilar site, or over time, should a site's characteristics vary due to some exogenous occurrence, such as a suntan.

Those skilled in the art will recognize that sophisticated multivariate techniques such as those outlined in the cited Wang references, above, may also be implemented, and that in general the methods developed for analytical instrument standardization are applicable to a wide variety of inter-person standardization problems.

Accordingly, one embodiment of the invention is directed to a method for reducing the effects of inter-subject variation on the analysis of spectra collected from the skin of two or more different subjects, comprising the step of correcting for the differences between spectra collected from the two or more subjects. Preferably, the step of correcting comprises using an inter-subject transfer function. For example, in a preferred embodiment the inter-subject transfer function may comprise application of the following formula:

Spectrum_{A Bi} [symbol]=Spectrum_{Ai}×[<Spectrum_{B}>/<Spectrum_{A}>],

where <Spectrum_{X}> is defined as the mean spectrum of X.

Other calibration models, such as those discussed in the attached documents, may likewise be utilized where applicable.

Another embodiment is directed to an instrument for measuring a glucose level of a plurality of individuals comprising means for collecting spectra emitted from a first individual's skin, and means for analyzing the collected spectra to determine the individual's glucose level, said means for analyzing comprising means for correcting for variations in spectra among individuals caused by variations in skin parameters, e.g., pigment content, hair content and color, roughness, moisture content, age, wrinkles, thickness, and the like.

In addition to accommodating for variations between different individuals, the methods of the invention can be used to correct for variations between different surfaces or locations on the same individual, as well as variations in the same location on the same individual, due to, for example, tanning.

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference, including, but not limited to, U.S. patent application Ser. No. 09/287,486, filed Apr. 6, 1999. U.S. Patent Application titled “Multivariate Analysis of Green to Ultraviolet Spectra of Cell and Tissue Samples,” U.S. Patent Application titled “Generation of Spatially-Averaged Excitation-Emission Map in Heterogeneous Tissue,” and U.S. patent application titled “Non-Invasive Tissue Glucose Level Monitoring,” all filed contemporaneously herewith, are entirely and specifically incorporated by reference. It is intended that the specification and examples be considered exemplary only, with the true scope and spirit of the invention indicated by the following claims.

1. A method for reducing the effects of inter-subject variation on the analysis of spectra collected from the skin of two or more different subjects, comprising the step of
correcting for the differences between spectra collected from said two or more subjects.

2. The method of claim 1 wherein the step of correcting comprises using an inter-subject transfer function.

3. The method of claim 2 wherein the inter-subject transfer function comprises application of the following formula:
Spectrum_{A Bi} [symbol]=Spectrum_{Ai}×[<Spectrum_{B}>/<Spectrum_{A}>],
wherein <Spectrum_{X}> is defined as the mean spectrum of X, and Spectrum A and Spectrum B are spectra of different individuals.

4. The method of claim 1 wherein said inter-subject variation is caused by a difference in a skin parameter, between said subjects, selected from the group consisting of: pigment content, hair content and color, roughness, moisture content, age, wrinkles, thickness, tanning, and any combination thereof.

5. An instrument for measuring an analyte level of a plurality of individuals comprising:
means for collecting spectra emitted from a first individual's skin;
means for analyzing the collected spectra to determine the individual's analyte level, said means for analyzing comprising means for correcting for variations in spectra among other individuals.

6. The instrument of claim 5 wherein said analyte is glucose.
